(19) United States
(12) Patent Application Publication
(10) Pub. No.: US 2025/0282576 A1
(43) Pub. Date: Sep. 11, 2025

(54) ELEVATOR CABIN AND ELEVATOR SYSTEM COMPRISING SUCH A CABIN

(71) Applicant: WITTUR HOLDING GMBH, WIEDENZHAUSEN, BAYERN (DE)

(72) Inventors: ALEXANDRO MORANDUZZO, MILANO (IT); MURAT VATANSEVER, BERGAMO (IT); OMER KARACA, GORLE (IT)

(21) Appl. No.: 18/862,773

(22) PCT Filed: Jun. 28, 2023
(86) PCT No.: PCT/IB2023/056703

§ 371 Date: Nov. 4, 2024

(30) Foreign Application Priority Data
Oct. 7, 2022 (IT) 102022000020700

(51) Int. Cl. B66B 11/02

(52) U.S. Cl. CPC B66B 11/024

(57) ABSTRACT

Elevator cabin includes:—a platform having a peripheral edge;—at least one panel arranged near the peripheral edge for defining a wall and comprising an end portion folded outwardly of the platform, a plurality of first through openings being obtained along said end portion; and—a bracket having an extension along a main direction following a section of the peripheral edge and comprising a first portion mounted on the peripheral edge and a second portion originating from the first portion with an extension away therefrom at a first distance above the platform. The bracket and the platform internally delimit a gap. The second portion has a plurality of second through openings. The end portion is arranged on the bracket so that the first through openings are at least partially superimposed on the second through openings whereby said gap communicates with an external environment.

### TECHNICAL FIELD

The present invention relates to an elevator cabin and an elevator system comprising such a cabin. In particular, the present invention relates to the ventilation of air between the cabin and the external environment.

### BACKGROUND ART

In accordance with EN81-20/50, ventilation holes must be provided in the elevator cabin to ensure a minimum air exchange of at least 1% of the total volume of the cabin itself in the upper part and 1% in the lower part. To address the ventilation of the lower part, the most adopted solution is to insert ventilation holes on the entrance walls of the cabin (or on the panels of the walls themselves). Another solution involves the use of rubber spacers to generate a ventilation gap between brackets and walls.

Both solutions involve the ventilation system being visible from inside the cabin. This is generally not appreciated by the end user, in particular in situations of poor maintenance and cleaning (dust and lint can easily remain stuck in these holes and their cleaning is difficult).

A known solution is described in JPS5377568 U. This document shows a ventilation gap which is created between a C-shaped bracket mounted on the cabin platform and facing outwards and an L-shaped portion integral with the wall panel. The L-shaped portion and the C-shaped bracket are interconnected and kept spaced by pins.

### DISCLOSURE OF THE INVENTION

In this context, the technical task underlying the present invention is to propose an elevator cabin which overcomes the drawbacks in the known art as described above.

In particular, it is an object of the present invention to propose an elevator cabin, in which the ventilation holes are not visible to passengers, but at the same time the cabin ventilation complies with regulations.

The stated technical task and the specified objects are substantially achieved by an elevator cabin, comprising:
a platform having a peripheral edge;
at least one panel arranged near the peripheral edge for defining a wall, said at least one panel comprising an end portion folded outwardly of the platform, a plurality of first through openings being obtained along said end portion;
a bracket having an extension along a main direction following a section of said peripheral edge, said bracket comprising a first portion mounted on said peripheral edge and a second portion originating from the first portion with an extension away therefrom, said second portion being located at a first distance above the platform,
said bracket and said platform internally delimiting a gap;
said second portion having a plurality of second through openings, said end portion being arranged on the bracket so that the first through openings are at least partially superimposed on the second through openings whereby said gap communicates with an external environment.

In accordance with an embodiment, the second portion has an extension on a plane parallel to the platform.

In accordance with an embodiment, the first portion has an extension on a plane orthogonal to the second portion.

In accordance with an embodiment, the first portion has an extension on a plane orthogonal to the platform.

In accordance with an embodiment, the bracket has an L-shaped profile.

In accordance with an embodiment, the first through openings and/or the second through openings have an elongated shape.

In accordance with an embodiment, the end portion is resting on the second portion of the bracket and is constrained thereto.

In accordance with an embodiment, the platform comprises a bottom surface and a flank, the first portion of the bracket being fixed to the flank.

In accordance with an embodiment, the peripheral edge comprises a plurality of sides, said bracket having an extension such as to follow one side of the peripheral edge.

### BRIEF DESCRIPTION OF DRAWINGS

Further features and advantages of the present invention will become more apparent from the indicative and thus non-limiting description of a preferred but non-exclusive embodiment of an elevator cabin and an elevator system, as illustrated in the appended drawings, in which:

FIG. 1 illustrates a perspective view of a part (panel and platform) of an elevator cabin, according to the present invention;

FIG. 2 illustrates a detail of the coupling between panel and platform of the cabin of FIG. 1;

FIG. 3 illustrates a lower part of an elevator cabin, according to the present invention.

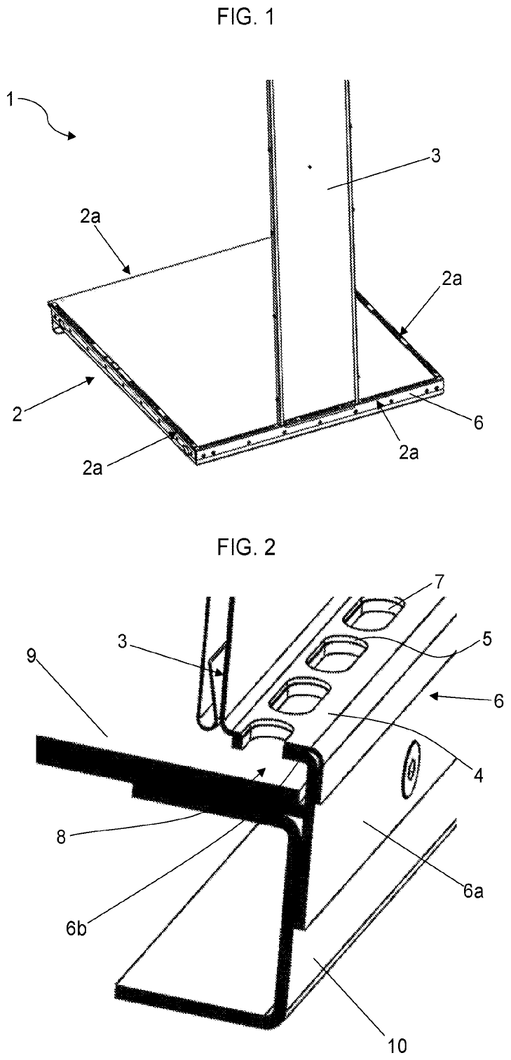

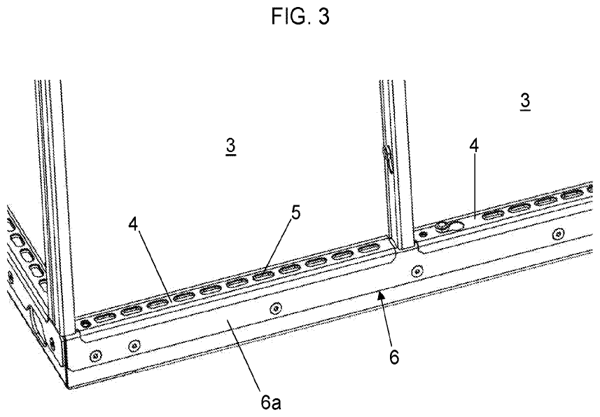

### DETAILED DESCRIPTION OF PREFERRED EMBODIMENTS OF THE INVENTION

With reference to the figures, reference numeral 1 indicates an elevator cabin.

The cabin 1 comprises a platform 2. The platform 2 has a peripheral edge 2a. Typically, the platform 2 has a polygonal shape. In such a case, the peripheral edge 2a consists of sides.

As is customary practice, the platform 2 preferably has a quadrilateral shape, in particular rectangular or square. The platform 2 has a planar extension, which in mounted conditions corresponds to a horizontal plane defining a bottom of the cabin 1.

The cabin 1 comprises at least one panel 3 arranged near the peripheral edge 2a for defining a wall. One side of the platform 2 corresponds to a wall.

Preferably, the panel 3 has a prevalently planar extension along a first direction and a second direction orthogonal to each other. In other words, it has two prevalent extension components: a length (or height) and a width. The extension of the panel 3 along a transverse direction with respect to the plane, also known as the thickness of the panel 3, is very reduced with respect to the other two dimensions.

Preferably, the panel 3 is substantially rectangular.

The panel 3 comprises an end portion 4 folded outwardly of the platform 2. Such an end portion 4 is situated at a bottom of the panel 3, i.e., the portion of the panel 3 closest to the platform 2.

A plurality of first through openings 5 is obtained along the end portion 4. Preferably, the first through openings 5 are oval. Preferably, the first through openings 5 have an elongated shape. Such a shape is identified in mechanics as “slot”. That is, the first through openings 5 are eyelets.

The cabin 1 comprises a bracket 6 having an extension along a main direction following a section of the peripheral edge 2a.

The bracket 6 comprises a first portion 6a mounted on the peripheral edge 2a. The bracket 6 comprises a second portion 6b originating from one end of the first portion 6a with an extension away therefrom. The second portion 6b is located at a first distance above the platform 2. That is, the second portion 6b is suspended shelved above the platform 2. Thereby, the bracket 6 and the platform 2 internally delimit a gap 8.

The second portion 6b has a plurality of second through openings 7. Preferably, the second through openings 7 are oval. Preferably, the second through openings 7 have an elongated shape. Such a shape is identified in mechanics as “slot”. That is, the second through openings 7 are eyelets.

Preferably, the second through openings 7 are counter-shaped to the first through openings 5.

The end portion 4 is arranged on the second portion 6b so that the first through openings 5 are at least partially superimposed on the second through openings 7. Preferably, the first through openings 5 and the second through openings 7 are entirely superimposed.

The second portion 6b has the function of supporting the end portion 4 which is raised with respect to the platform 2.

Preferably, the end portion 4 is resting on the second portion 6b and is constrained thereto. For example, one or more screws or one or more bushings or a combination of screws and bushings are used.

Alternatively, the end portion 4 is located above the second portion 6b with an interposed spacer, for example an anti-slip layer.

The gap 8 communicates with an environment outside the cabin 1 exclusively by means of the through openings 5, 7. On the opposite side with respect to the first portion 6a of the bracket, the gap 8 is not physically delimited and communicates with an internal environment of the cabin 1. Therefore, the gap 8 acts as an antechamber for the passage of air. The air from the outside enters through the openings 5, 7 in the gap 8 and then into the cabin. Conversely, the air from the cabin passes through the gap 8 and exits from the openings 5, 7.

Suitably, since the end portion 4 is folded outwards, the body of the panel 3 is more internal with respect to the end edge of the platform 2.

Preferably, the second portion 6b has an extension on a plane parallel to the platform 2.

Preferably, the first portion 6a has an extension on a plane orthogonal to the second portion 6b. In the preferred embodiment, illustrated in the figures, the bracket 6 has an L-shaped profile. In mounted conditions, the L-shaped profile is overturned.

Preferably, the first portion 6a has an extension on a plane orthogonal to the platform 2.

Preferably, the platform 2 comprises a bottom surface 9 and a flank 10. The first portion 6a is fixed to the flank 10. Preferably, the flank 10 has a square U-shaped profile, with the middle portion facing outwards.

In the preferred embodiment, several panels 3 are side by side to define a wall of the cabin 1. In such a case, a single bracket 6 is provided for the internal side of the wall. The bracket 6 has an extension such as to follow the side of the peripheral edge 2a.

The subject matter of the present invention is an elevator system. The elevator system comprises a cabin 1 according to what has been described.

The features of the elevator cabin and elevator system emerge clearly from the above description, as do the advantages.

In particular, the described configuration of the bracket and the panel allows the formation of the hidden gap. This allows an optimal passage of air between the cabin and the external environment, complying with regulations, and at the same time makes the ventilation openings hidden from the passengers' view.

1. An elevator cabin (1) comprising:
a platform (2) having a peripheral edge (2a);
at least one panel (3) arranged near the peripheral edge (2a) for defining a wall, said at least one panel (3) comprising an end portion (4) folded outwardly of the platform (2);
a bracket (6) having an extension along a main direction following a section of said peripheral edge (2a), said bracket (6) comprising a first portion (6a) mounted on said peripheral edge (2a) and a second portion (6b) originating from the first portion (6a) with an extension away therefrom, said second portion (6b) being located at a first distance above the platform (2),
wherein a plurality of first through openings (5) are obtained along said end portion (4);
said bracket (6) and said platform (2) delimiting a gap (8);
said second portion (6b) having a plurality of second through openings (7), said end portion (4) being arranged on the bracket (6) so that the first through openings (5) are at least partially superimposed on the second through openings (7).

2. The cabin (1) according to claim 1, wherein the second portion (6b) has an extension on a plane parallel to the platform (2).

3. The cabin (1) according to claim 1, wherein the first portion (6a) has an extension on a plane orthogonal to the second portion (6b).

4. The cabin (1) according to claim 1, wherein the first portion (6a) has an extension on a plane orthogonal to the platform (2).

5. The cabin (1) according to claim 1, wherein the bracket has an L-shaped profile.

6. The cabin (1) according to claim 1, wherein the first through openings (5) and/or the second through openings have an elongated shape.

7. The cabin (1) according to claim 1, wherein the end portion (4) is resting on the second portion (6b) of the bracket (6) and is constrained thereto.

8. The cabin (1) according to claim 1, wherein the platform (2) comprises a bottom surface (9) and a flank (10), the first portion (6a) of the bracket (6) being fixed to the flank (10).

9. The cabin (1) according to claim 1, wherein the peripheral edge (2a) comprises a plurality of sides, said bracket (6) having an extension to follow one side of the peripheral edge (2a).

10. An elevator system, comprising an elevator cabin (1) according to claim 1.
